(19) United States
(12) Patent Application Publication
(10) Pub. No.: US 2023/0032201 A1
(43) Pub. Date: Feb. 2, 2023

(54) METHOD FOR PERFORMING AN OFFLINE TRANSACTION

(71) Applicant: TRUST ANCHOR GROUP IPR AB, Stockholm (SE)

(72) Inventor: Peter WAHER, SALTSJÖ-BOO (SE)

(73) Assignee: TRUST ANCHOR GROUP IPR AB, Stockholm (SE)

(21) Appl. No.: 17/784,195

(22) PCT Filed: Dec. 11, 2020
(86) PCT No.: PCT/SE2020/051198

§ 371 Date: Jun. 10, 2022

(30) Foreign Application Priority Data
Dec. 11, 2019 (SE) 1951426-4

(51) Int. Cl. G06Q 20/38; G06Q 20/12; G06Q 20/32; G06Q 20/40; H04L 9/08

(52) U.S. Cl. CPC G06Q 20/3829; G06Q 20/127; G06Q 20/3274; G06Q 20/3825; G06Q 20/389; G06Q 20/4014; H04L 9/0825

(57) ABSTRACT

The present disclosure generally relates to a novel computer implemented method for performing an offline transaction between a first user operating a first electronic device and a second user operating a second electronic device. The present disclosure also relates to a corresponding first electronic device and a computer program product.

### TECHNICAL FIELD

The present disclosure generally relates to a novel computer implemented method for performing an offline transaction between a first user operating a first electronic device and a second user operating a second electronic device. The present disclosure also relates to a corresponding first electronic device and a computer program product.

### BACKGROUND

There is an increasing trend in using credit cards or other online banking functionality (such as e.g. PayPal, UPI, Worldpay, etc.) for settling monetary transactions between consumers and sellers, whether they are individuals or companies. However, it is a prerequisite to have an available network connection with e.g. an online payment provider for ensuring some level of security for such monetary transactions. When no network connection is available, the monetary transactions must be settled using “classical means”, such as cash and checks. Unfortunately, cash and checks may easily be counterfeited and or otherwise manipulated.

An example of an implementation trying to contravene this problem is disclosed in WO2015148850, presenting a method for facilitating a payment transaction between a user mobile communication device and a merchant communication device. The payment transaction can in accordance to the disclosure of WO2015148850 be performed without the user mobile communication device and the merchant communication device having network access.

Even though WO2015148850 provides an interesting approach to contravening general problems with prior art, there is always room for further improvements and expansion of such technology, with the intention to reduce computational complexity while at the same time improving security when settling monetary transactions.

### SUMMARY

According to an aspect of the invention, the above is at least partly alleviated by a computer implemented method for performing an offline transaction between a first user operating a first electronic device and a second user operating a second electronic device without involving a transaction server, the first electronic device storing a private key for the first user and the second electronic device storing a public key for the first user and relating to the first user's private key, wherein the method comprises the steps of selecting, at the first electronic device, an amount of funds to be transferred, receiving, at the first electronic device, an identity of the first user, receiving, at the first electronic device, an indicator of a transaction server adapted to transfer the selected amount, forming an offline transaction string based on the selected amount, the identity of the first user and the indicator of the transaction server using the first electronic device, signing at least a portion of the offline transaction string using a private key for the first user using the first electronic device, receiving the offline transaction string at the second electronic device, and validating the offline transaction string using the public key for the first user using the second electronic device.

In accordance to the present disclosure, there is provided a scheme for allowing a true offline transaction to take place between the first and the second user, without the necessity to involve a transaction server. This may for example be compared to prior-art implementations where the first electronic device as a pre-requisite to performing transaction must be connected to the transaction server, where the “pre-transaction connection” includes allocating funds for the first electronic device. The allocated funds may then be transferred to e.g. a merchant when performing the transaction of buying a product or service from the merchant.

In line with the present disclosure, when the first and a second user operating a first and a second electronic device, respectively, agree on making a transaction, but access to a transaction server is not available, the first electronic device may be used to generate an offline transaction string containing all the information necessary to perform the transaction. The offline transaction string, preferably encoded using e.g. a URI scheme, may be transferred from the first to the second electronic device by using wireless communication means, such as Bluetooth, near-field radio, optical means, etc. It could also be possible to transmit the offline transaction string using different messaging services, again not involving the transaction server.

In comparison, general prior-art implementations may only be seen allowing for a quasi-offline transaction to take place, since the transaction only is allowed to take place if the pre-transaction connection has been completed between the first electronic device and the server. Conversely, the scheme as defined by the present disclosure allows the transaction to be a true offline transaction, since the transaction between the first and the second electronic device may be performed without any involvement with the transaction server, for example to allocate funds belonging to the first user to be transferred to the second user.

A further difference between the scheme according to the present disclosure and suggested prior art solutions lies in the fact that in accordance to the present disclosure the first user makes a commitment to the second user that the fund is to be transferred from the first to the second user. Accordingly, even without making a pre-transaction connection between the first electronic device and the transaction server to allocate the funds to be transferred to the second user, the second user can rely on the fact that the first user has privately signed the transaction, meaning that the second user legally could claim the funds from the first user in case no funds are available when the second user (in a subsequent step and as discussed below) request the fund (in the end is) to be transferred to the second user.

In line with the present disclosure, it is thus possible to “double spend”, but the commitment made by the first user to the second user ensures that the transaction is legally binding, by means of the private key for the first user. The private key for the first user is in turn preferably cryptographically and by non-repudiation connected to an attested and/or verifiable identity. In some embodiments it may for example be possible to ensure that the private key for the first user is attested by an in advance trusted third party, such as a trust provider, a bank, etc.

The knowledge that the transaction is legally binding has shown to be reliable to an adequate level for allowing this type of transaction to be performed at a high level of security. Furthermore, the solution as is presented by the present disclosure ensures that the true offline transaction may be performed in a non-repudiation fashion, meaning that the first user e.g. at a later stage cannot claim that the transaction never took place. The implementation according to the present disclosure thus makes it less attractive to perform a double spending.

At the same time, since the transaction may be performed in a truly offline fashion, a greater flexibility is introduced to the overall payment service. The first user knows that he will always be able to make a payment for e.g. a product and/or service purchased from the second user even if in an area where no network connection is available to in advance allocate funds to be transferred to the second user.

Furthermore, according to the present disclosure the delivery of the offline transaction string must not necessary be in electronic form. Rather, in an alternative embodiment of the present disclosure the method further comprises the steps of forming a graphical representation of the offline transaction string and printing the graphical representation of the offline transaction string. Accordingly, the first user could possibly print the offline transaction string on any piece of material and give to the second user. Along the same line, the offline transaction string could be converted to e.g. a barcode (such as a QR code or similar) and printed on a piece of paper that can be “scanned” using the second electronic device. It could of course also be possible to provide the second electronic device with a user interface allowing e.g. the second user to manually input the offline transaction string at the second electronic device. It should however be understood that the offline transaction string in an alternative embodiment of the present disclosure may be provided to the second user/electronic device by hand or orally. Additionally, the offline transaction string could still further be written down manually or possibly entered manually using a user interface of the second electronic device.

The second electronic device (or even the first electronic device or any other party) can then send the offline transaction string to a transaction server arranged for implementing functionality to perform the transfer of the amount of funds from the first to the second user, for example at a later stage when connectivity is available, or when convenient or necessary.

Thus, once the offline transaction string has been received by the second electronic device, the second electronic device may be arranged in communication with the transaction server for transmitting the offline transaction string from the second electronic device to the transaction server, where after the transaction server may transfer the amount of funds to the second user.

It should be understood that the expression “user” should be interpreted in the broadest sense. In some embodiment the (e.g. first or second) user may be a person. However, within the context of the present disclosure a user may also be for example a service, entity or infrastructure node. Other type of entities is of course possible and within the scope of the present disclosure.

In line with the present disclosure and as mentioned above the identity of the first user is part of the offline transaction string. It is preferred that the identity of the first user is a legal identity, for example ensured by a third party of some form. The identity is generally verified at the second user device using public key for the first user. The identity of the first user is typically also validated at the transaction server using the public key for the first user.

In some embodiments it may also be desirable to include the identity of the second user with the offline transaction string, such that only the second user will be allowed to receive the amount of funds to be transferred. That said, it could also and with the scope of the present disclosure be possible to allow the offline transaction string to be formed without the identity of the second user, meaning that any person receiving the offline transaction string could receive the funds to be transferred.

Preferably, as soon as the first electronic device has provided the offline transaction string to the second electronic device, it makes sure to reserve the corresponding amount in its local copy of the balance. As soon as the first electronic device at e.g. a later stage connects to the transaction server, it also sends the offline transaction string. It also synchronizes its local balance with the transaction server.

As the first electronic device makes sure the local balance is not higher than the true balance, it is very difficult to generate an offline transaction that cannot be covered by the amount of funds stored in an account at or arranged in relation to the transaction server.

It should further be understood that it in line with the present disclosure may be possible to put one or a plurality of payment conditions on the transfer. Accordingly, it could in line with the present disclosure be possible to only perform the step of transferring the amount of funds to the second user if the one or plurality of payment conditions are fulfilled. Also, it may be possible to dictate that the step of transferring the amount of funds to the second user is only performed once.

One example of such a payment condition could for example be time based, meaning that it may be possible for the first user to embed information as to when in time the transfer could be performed. For example, there may be a time-based payment condition dictating that the transfer must be made before a first specific time or not after a second specific time.

Another example of such a payment condition could for example be dictated by a legal agreement reached by the first and the second user, or possibly a further third party. For example, it may be possible to allow the transfer to only be completed if the second user fulfills an agreed service, etc. Such an implementation could for example be useful in relation to services provided in a home or office (involving a carpenter, etc.).

Advantageously, the offline transaction string is further formed based on a preselected encryption scheme, where the preselected encryption scheme for example may be based on Elliptic Curve Cryptography (ECC). Other encryption schemes are of course possible and within the scope of the present disclosure. The encryption scheme used may possibly be embedded with the offline transaction string (however not encrypted) and/or communicated separately and/or agreed upon beforehand.

According to an aspect of the present disclosure, there is further provided a first electronic device operated by a first user and adapted to perform an offline transaction with a second electronic device operated by a second user without involving a transaction server, the first electronic device storing a private key for the first user and the second electronic device storing a public key for the first user and relating to the first user's private key, wherein the first electronic device is adapted to receive information indicative of an amount of funds to be transferred, receive an identity of the first user, receive an indicator of the transaction server adapted to transfer the selected amount, form an offline transaction string based on the selected amount, the identity of the first user and the indicator of a transaction server, sign at least a portion of the offline transaction string using a private key for the first user using the first, and provide the offline transaction string at the second electronic device, wherein the offline transaction string is validated at the second electronic device using the public key for the first user. This aspect of the present disclosure provides similar advantages as discussed above in relation to the previous aspects of the present disclosure.

It may be possible to provide the first electronic device according to the present disclosure as a component of a computer system, further comprising a second electronic device, the second electronic device being different from the first electronic device, and a transaction server.

According to a further aspect of the present disclosure, there is provided a computer program product comprising a non-transitory computer readable medium having stored thereon computer program means for operating a first electronic device operated by a first user and adapted to perform an offline transaction with a second electronic device operated by a second user without involving a transaction server, the first electronic device storing a private key for the first user and the second electronic device storing a public key for the first user and relating to the first user's private key, wherein the computer program product comprises code for receiving information indicative of an amount of funds to be transferred, code for receiving an identity of the first user, code for receiving an indicator of a transaction server adapted to transfer the selected amount, code for forming an offline transaction string based on the selected amount, the identity of the first user and the indicator of the transaction server, code for signing at least a portion of the offline transaction string using a private key for the first user using the first, and code for provide the offline transaction string at the second electronic device, wherein the offline transaction string is validated at the second electronic device using the public key for the first user. Also, this aspect of the present disclosure provides similar advantages as discussed above in relation to the previous aspects of the present disclosure.

A software executed by the transaction server for operation in accordance to the present disclosure may be stored on a computer readable medium, being any type of memory device, including one of a removable nonvolatile random access memory, a hard disk drive, a floppy disk, a CD-ROM, a DVD-ROM, a USB memory, an SD memory card, or a similar computer readable medium known in the art.

In summary, the present disclosure generally relates to a novel computer implemented method for performing an offline transaction between a first user operating a first electronic device and a second user operating a second electronic device without involving a transaction server, making the transaction between the first electronic device and the second electronic device a true offline transaction. The present disclosure also relates to a corresponding first electronic device and a computer program product.

Further features of, and advantages with, the present disclosure will become apparent when studying the appended claims and the following description. The skilled addressee realizes that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates a computer system according to an embodiment of the present disclosure, and

FIG. 2 is a flow chart illustrating the steps of performing the method according to a currently preferred embodiment of the present disclosure.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled person. Like reference characters refer to like elements throughout. The following examples illustrate the present disclosure and are not intended to limit the same.

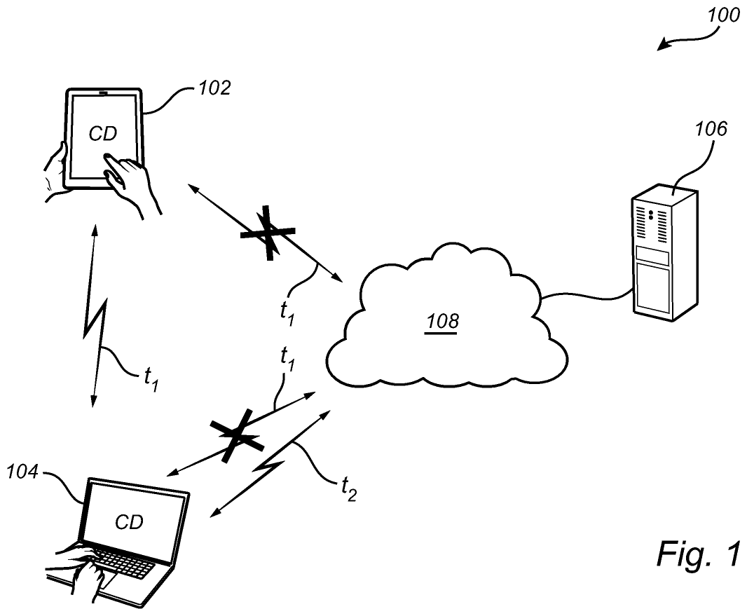

Turning now to the drawings and to FIG. 1 in particular, there is conceptually illustrated a computer system 100 according to an embodiment of the present disclosure. The computer system 100 comprises a first electronic device 102 and a second electronic device 104, as well as a transaction server 106. The electronic devices 102, 104 may for example include mobile phones, desktop computers, laptops, tablets, etc.

Possibly, server 106 may be part of a so-called cloud-based computing system and the server 106 may be a cloud server. Thus, the computing power provided by the transaction serve 106 may be distributed between a plurality of servers, and the location of the servers must not be explicitly defined. Advantageous following the use of a cloud-based solution is also the inherent redundancy achieved.

The purpose of the computer system 100 is, in one embodiment, to allow a predetermined amount of funds to be transferred from a first user operating the first electronic device 102 to a second user operating the second electronic device 104, even in a situation (represented in FIG. 1 with t₁) where neither of the first 102 and the second 104 electronic device are connected to the transaction server 106 by means of a network connection, such as over the Internet 108.

However, at a later stage when e.g. the second electronic device 104 is connected to the transaction server 106 (represented in FIG. 1 with t₂), the predetermined amount of funds may be transferred from e.g. an account of the first user to an account of the second user.

For reference, the first 102 and the second 104 electronic device comprises processing circuitry arranged to at least in part perform the scheme according to the present disclosure. The processing circuitry may for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

Furthermore, the first 102 and the second 104 electronic device each typically comprises a transceiver (not shown) adapted to allow for any form of wireless connection directly between the first 102 and the second 104 electronic device, or between each of the first 102 and the second 104 electronic device and the transaction server 106. The transceivers may for example be adapted for allowing communication using WLAN, CDMA, GSM, GPRS, 3/4/5G mobile communications, or similar. Other present of future wireless communication protocols are possible and within the scope of the present disclosure.

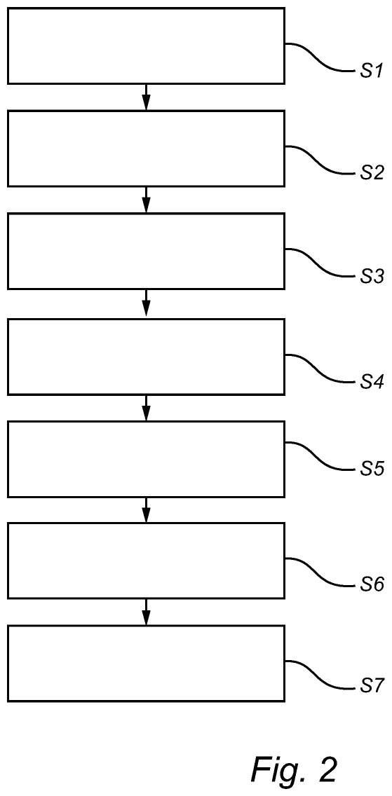

During operation, with further reference to FIG. 2 illustrating an exemplary implementation of the scheme according to the present disclosure, the first electronic device 102 receives, S1, information indicative of an amount of funds to be transferred. The amount of funds to be transferred may be in any present or future currency. Such information could for example be provided by the first user using a graphical user interface of the first electronic device 102. It could however be possible to use e.g. a camera or near field communication means comprised with the first electronic device 102 for collecting information indicative of the amount of funds to be transferred.

The first electronic device 102 also receives, S2, an identity of the first user. The identity could for example be received from a memory element comprised with the first electronic device 102 (or another electronic device arranged in communication with the first electronic device 102. The identity could possibly be received if the first user presents biometric information that may be successfully validated.

Still further, the first electronic device 102 receives, S3, an indicator of a transaction server adapted to transfer the selected amount. The indicator for the transaction server 106 could for example be a web address, domain name, an IP address, etc.

Once the first electronic device 102 has at least information indicative of an amount of funds to be transferred, the identity of the first user and the indicator for the transaction server 106, the first electronic device 102 forms, S4, an offline transaction string. The formation of the offline transaction string could in a simple implementation be performed by concatenating the information indicative of an amount of funds to be transferred, the identity of the first user and the indicator for the transaction server 106. However, other types of algorithms may be used and are within the scope of the present disclosure.

The offline transaction string is in turn, at least partly, signed, S5 using a private key for the first user. The private key for the first user is part of a key pair. At least the private key may typically be stored with the memory element comprised with the first electronic device 102.

The offline transaction string is then provided, S6, to the second electronic device 104. As mentioned above, transferring the offline transaction string from the first 102 to the second 104 electronic device is performed directly between the first 102 to the second 104 electronic device without involving the transaction server (e.g. t₁). The first electronic device 102 could for example generate a barcode, such as a QR code, being a representation of the offline transaction string that is printed or shown at the GUI of the first electronic device 102. The second electronic device 104 may as such for example be provided with a camera (not shown) that is arranged to capture the information comprised with the QR code and then extract the offline transaction string from the QR code.

To ensure that the offline transaction string is correct and securely related to the identity of the first user, the second electronic device 104 validates, S7, the offline transaction string using the public key for the first user. In such an embodiment it is desirable that the second electronic device 104 has previously received the public key for the first user in a safe and trustworthy manner, whereby the second user can trust that the identity of the first user is correctly connected to the public key. The public key could for example be provided to the second electronic device 104 as part of a legal verification of the identity of the first user, such as by the first user presenting a valid identity card.

At a later stage, where e.g. the second electronic device 104 has a connection to the transaction server 106, the second electronic device 104 transmits the offline transaction string to the transaction server 106 (e.g. t₂). The transaction server 106 may then (after performing necessary validations) transfer the amount of funds to the second user.

The control functionality of the present disclosure may be implemented using existing computer processors, or by a special purpose computer processor for an appropriate system, incorporated for this or another purpose, or by a hardwire system. Embodiments within the scope of the present disclosure include program products comprising machine-readable medium for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A computer implemented method for performing an offline transaction between a first user operating a first electronic device and a second user operating a second electronic device without involving a transaction server, the first electronic device storing a private key for the first user and the second electronic device storing a public key for the first user and relating to the first user's private key, wherein the method comprises:
selecting, at the first electronic device, an amount of funds to be transferred,
receiving, at the first electronic device, an identity of the first user,
receiving, at the first electronic device, an indicator of a transaction server adapted to transfer the selected amount,
forming an offline transaction string based on the selected amount, the identity of the first user and the indicator of the transaction server using the first electronic device,
signing at least a portion of the offline transaction string using a private key for the first user using the first electronic device,
receiving the offline transaction string at the second electronic device, and
validating the offline transaction string using the public key for the first user using the second electronic device.

2. The method according to claim 1, wherein the offline transaction string is received at the second electronic device from the first electronic device using direct communication between the first and the second electronic device.

3. The method according to claim 2, wherein the direct communication between the first and the second electronic device is implemented using a wireless communication protocol.

4. The method according to claim 1, further comprising:
forming a graphical representation of the offline transaction string, and
printing the graphical representation of the offline transaction string.

5. The method according to claim 4, wherein the graphical representation is a barcode.

6. The method according to claim 1, wherein the offline transaction string is further formed based on a payment condition.

7. The method according to claim 6, wherein the payment condition is time-based.

8. The method according to claim 1, wherein the offline transaction string is further formed based on a preselected encryption scheme.

9. The method according to claim 8, wherein the preselected encryption scheme is based on Elliptic Curve Cryptography (ECC).

10. The method according to claim 1, wherein the offline transaction string is further formed based on an identity of the second user.

11. The method according to claim 1, further comprising the steps of:
transmitting the offline transaction string from the second electronic device to the transaction server, and
transferring, using the transaction server, the amount of funds to the second user.

12. The method according to claim 11, wherein the identity of the first user is validated at the transaction server using the public key for the first user.

13. The method according to claim 11, wherein the offline transaction string is further formed based on a payment condition, and wherein the transferring the amount of funds to the second user is only performed if the payment condition is fulfilled.

14. The method according to claim 11, wherein the transferring the amount of funds to the second user is only performed once.

15. The method according to claim 1, wherein the identity of the first user is a verifiable identity.

16. A first electronic device operated by a first user and adapted to perform an offline transaction with a second electronic device operated by a second user without involving a transaction server, the first electronic device storing a private key for the first user and the second electronic device storing a public key for the first user and relating to the first user's private key, wherein the first electronic device is adapted to:
receive information indicative of an amount of funds to be transferred,
receive an identity of the first user,
receive an indicator of a transaction server adapted to transfer the selected amount,
form an offline transaction string based on the selected amount, the identity of the first user and the indicator of the transaction server,
sign at least a portion of the offline transaction string using a private key for the first user, and
provide the offline transaction string at the second electronic device, wherein the offline transaction string is validated at the second electronic device using the public key for the first user.

17. A computer system comprising:
a first electronic device according to claim 16,
a second electronic device, the second electronic device being different from the first electronic device, and
a transaction server.

18. A computer program product comprising a non-transitory computer readable medium having stored thereon computer program means for operating a first electronic device operated by a first user and adapted to perform an offline transaction with a second electronic device operated by a second user without involving a transaction server, the first electronic device storing a private key for the first user and the second electronic device storing a public key for the first user and relating to the first user's private key, wherein the computer program product comprises
code for receiving information indicative of an amount of funds to be transferred,
code for receiving an identity of the first user,
code for receiving an indicator of a transaction server adapted to transfer the selected amount,
code for forming an offline transaction string based on the selected amount, the identity of the first user and the indicator of the transaction server,
code for signing at least a portion of the offline transaction string using a private key for the first user, and
code for providing the offline transaction string at the second electronic device, wherein the offline transaction string is validated at the second electronic device using the public key for the first user.

19. A computer implemented method for performing an offline transaction for allowing funds to be transferred between a first user operating a first electronic device and a second user operating a second electronic device, without involving a transaction server in the process of transferring the funds between the first user operating the first electronic device and the second user operating the second electronic device, the first electronic device storing a private key for the first user and the second electronic device storing a public key for the first user and relating to the first user's private key, wherein the method comprises:
selecting, at the first electronic device, an amount of funds to be transferred,
receiving, at the first electronic device, an identity of the first user,
receiving, at the first electronic device, an indicator of a transaction server adapted to be used for subsequently transfer the selected amount,
forming an offline transaction string based on the selected amount, the identity of the first user and the indicator of the transaction server using the first electronic device,
signing at least a portion of the offline transaction string using a private key for the first user using the first electronic device,
receiving the offline transaction string at the second electronic device, and
validating the offline transaction string using the public key for the first user using the second electronic device.

20. The method according to claim 19, wherein the offline transaction string is received at the second electronic device from the first electronic device using direct communication between the first and the second electronic device.
